(19) United States
(12) Patent Application Publication
(10) Pub. No.: US 2007/0106732 A1
(43) Pub. Date: May 10, 2007

(54) Mobile communication terminal and method therefor

(75) Inventor: Klaus Weis, Bochum (DE)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/270,895

(22) Filed: Nov. 10, 2005

(51) Int. Cl. G06F 15/16

(52) U.S. Cl. 709/206; 707/101; 715/500; 709/246

(57) ABSTRACT

A method is provided for string conversion starting with identifying an original string for correction and receiving a command specifying an input mode. The method also involves generating an input sequence corresponding to the original string and interpreting the sequence according to the input mode, which generates a corrected string that is used to replace the original string. A corresponding apparatus and computer program are also provided.

### FIELD OF THE INVENTION

The present invention generally relates to text input and particularly to predictive text input in mobile communications terminals.

### BACKGROUND

Mobile terminals, or mobile (cellular) telephones, for mobile telecommunications systems like GSM, UMTS, D-AMPS and CDMA2000 have been used for many years now. In the older days, mobile terminals were used almost only for voice communication with other mobile terminals or stationary telephones. More recently, the use of modem terminals has been broadened to include not just voice communication, but also various other services and applications such as www/wap browsing, video telephony, electronic messaging (e.g. SMS, MMS, email, instant messaging), digital image or video recording, FM radio, music playback, electronic games, calendar/organizer/time planner, word processing, etc.

In contemporary cellular telephones like the NOKIA 3230 expedient text input is of great importance to users as text message services are heavily dependent on a quick and easy way to input text to be efficient. The various input modes that are selectable are Predictive input, Multitap input and Number input or more specifically Predictive input first letter upper case ([->Abc]), Predictive input all lower case ([->abc]), Predictive input all upper case ([->ABC]), Multitap input first letter upper case ([Abc]), Multitap input all lower case ([abc]), Multitap input all upper case ([ABC]) and Number input ([123]). To change the input mode on the NOKIA™ 3230 the user may press the hash key (‘#’ key) repeatedly and step through the different input modes one by one until the desired input mode is reached. If the user wants to change to number input the user makes a longpress on the hash key. Alternatively the user could press the alpha key (Symbian Series 60™ specific key) which displays a menu list with input options including input mode change. This alternative way of switching input mode often requires more keypresses.

One common mistake made while inputting text is that the user forgets to change the input mode and the following input text is thus not correct and has to be corrected or rewritten. Assume that the user is using predictive input and wanted to input a name “Charles”, but forgot to change the input mode and input “charles” with a starting lower case ‘c’. To correct this mistake the user has to first change input mode from Predictive input all lower case, [->abc] (which is the most common input mode), to Multitap input either all upper case or first letter upper case, that is [ABC] or [Abc], and then scroll back to the beginning of the word, delete the erroneous letter and input the correct one using multitap. After the input has been corrected, the user has to change back to the input mode previously used, i.e., ->abc, and then possibly scroll to the end of the word and continue typing. Using the NOKIA 3230 a correction like this would require 2 (average key presses required to change input mode)+1 (scrolling)+1 (delete)+1 (correct input)+2 (average multitap input)+2 (new input mode change)=9 key presses. To make the length of the word irrelevant it is assumed that the scrolling only requires 1 keypress. Due to the advanced input method already implemented in the NOKIA 3230 the user does not have to scroll to the end of the word again, the predictive editor does that automatically when the user switches to a predictive input mode.

The situation gets even worse if the word has been input using the wrong input mode. If a user wanted to input “Charles” but forgot to change input mode and typed in the necessary sequence in a multitap input mode instead of in a predictive input mode, the result would be “agajdp”. To correct this, the user would need to delete the whole word, change the input mode and retype the word, thus causing the user to make 3×[word length]+2 (average to change input mode) keypresses.

Apart from having to make a lot of keypresses there are also a number of steps that need to be taken, and these might not be apparent to the average user who most likely will just opt to retype the whole word requiring even more keypresses. The process of realizing the error, taking steps to correct it and having to perform a lot of keypresses to accomplish this is often very frustrating to a user who wants to be able to input the text in a quick and easy way that does not require a lot of considerations for input techniques.

In case the user wanted to input a number (like 852852), but forgot to do so the number would be input as a word (“ulctla”) instead. Often the word would not make any sense at all, and most often the predictive editor would not recognize the word and just halt. As a typical user does not look at the screen when inputting text, but keep his gaze on the keypad, the user would not realize this until the input was done and thus would have made a lot of keypresses in vain. To correct wrongfully input number like this the user would have to rewrite the whole input string with the actions input mode change, repeated deletes, retyping and then an input mode change again, resulting in 2+6+6+2=14 keypresses for the example above.

Thus, this inability to easily correct input that has been done under the wrong input mode is a frustrating problem that requires a lot of steps and keypresses to correct and also contributes to users' unwillingness to learn and to use the text input features frequently.

### SUMMARY

According to an aspect of the invention, a method for string conversion comprises the steps of:
a) identifying an original string for correction;
b) receiving a command specifying an input mode;
c) generating an input sequence corresponding to said original string;
d) interpreting said input sequence according to said input mode thereby generating a corrected string; and
e) replacing said original string with said corrected string.

By allowing the user to re-interpret or convert an already input string according to a new input mode it is very easy to correct strings that have been erroneously input. Especially when the conversion or re-interpretation is to/from multitap from/to predictive input or from/to number to/from word as these errors requires a complete re-write of the word/number.

According to another aspect of the invention, a language dictionary is regarded as an input mode and a change of input mode generates a re-interpretation of the input sequence according to another dictionary. In this way it is easy to convert or re-interpret words that have been input using the wrong dictionary. As mistakes such as these, requires the user to re-write the whole string again in prior art systems, the benefits are clearly a much faster and easier to use method.

Another aspect of the invention includes a method for string conversion, wherein a step of generating an input sequence involves fetching an input sequence from a memory. By saving the original key sequence it is much easier to re-interpret the string, as the generation of an input sequence is only a memory access. If next character commands have been saved, as part of the input sequence, as this helps to determine whether a “b” is in fact a “b” or two “a”:s which makes it easier to clear any ambiguities.

A further aspect of the invention includes another method for string conversion, wherein a step of generating an input sequence involves creating an input sequence from the original string by mapping the original string to input means being used. By mapping the original string to the input means used in the device implementing the method, the user is both able to edit text written by someone else or on another device and also able to save memory space.

An additional aspect of the invention includes a device implementing a method according to the invention. As text input is very common on mobile communications terminals and also on personal computers, the invention may find particular advantage here.

A further aspect of the invention includes a computer program comprising software instructions that, when executed in a mobile communication terminal, performs a method according to another aspect of the invention.

Another aspect of the invention includes converting means for converting strings, comprising:
means for identifying an original string;
means for generating an input sequence from said original string;
means for establishing an input mode;
means for interpreting said input sequence according to said input mode and generating in a converted string; and
means for replacing said original string with said converted string.

Other features and advantages of the present invention will appear from the following detailed disclosure, from the attached dependent claims, and from the drawings.

Generally, all terms used in the claims are to be interpreted according to their ordinary meaning in the technical field, unless explicitly defmed otherwise herein. All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Example embodiments of the present invention will now be described in more detail, reference is being made to the enclosed drawings, in which:

FIG. 1 is a schematic illustration of a cellular telecommunication system, as an example of an environment in which aspects of the present invention may be applied.

FIG. 2 is a schematic front view illustrating a mobile terminal according to an embodiment of the present invention.

FIG. 3 is a schematic block diagram representing an internal component, software and protocol structure of the mobile terminal shown in FIG. 2.

FIG. 4a is a flow chart of a correction method according to an embodiment of the invention.

FIG. 4b is a flow chart of another correction method according to an embodiment of the invention.

FIGS. 5a-5j show a series of screen shots showing a correction of a name.

### DETAILED DESCRIPTION OF THE DRAWINGS

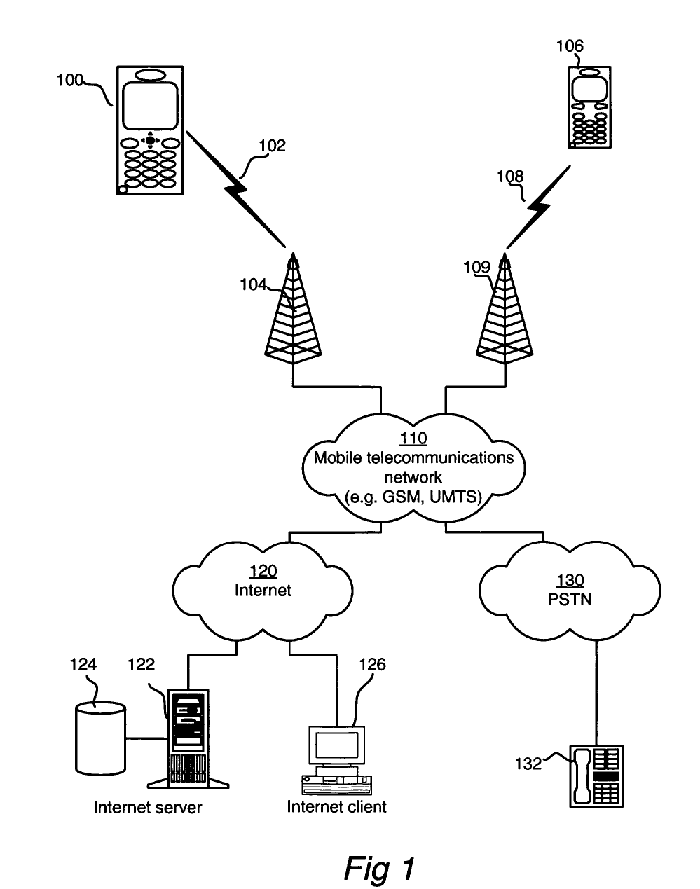

FIG. 1 illustrates an example of a cellular telecommunications system in which aspects of the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the present invention and other devices, such as another mobile terminal 106 or a stationary telephone 132. It is to be noted that for different embodiments of the mobile terminal 100 and in different situations, different ones of the telecommunications services referred to above may or may not be available; the invention is not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be the Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

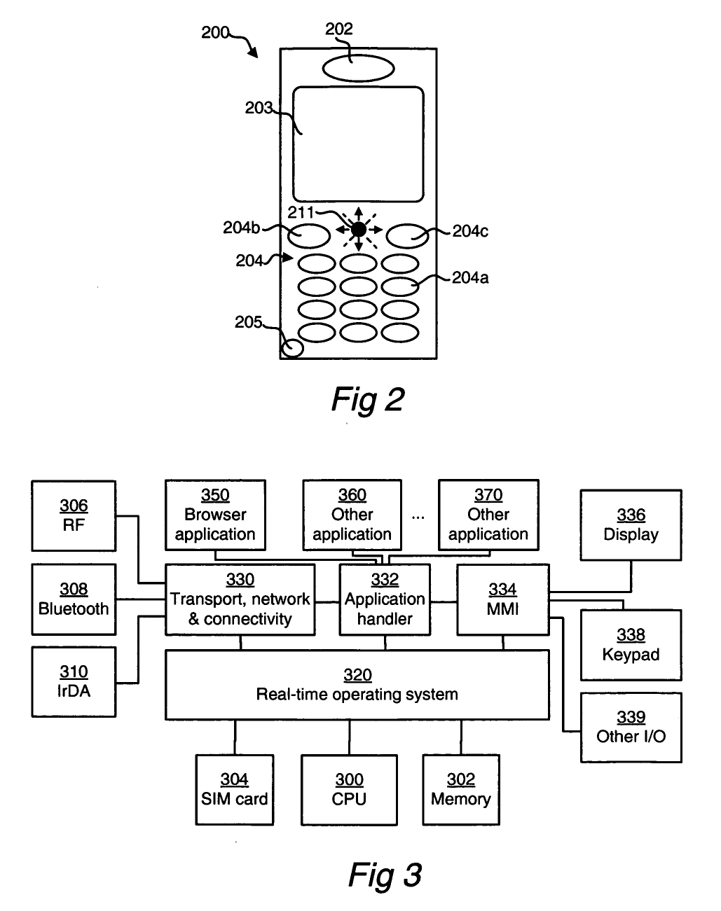

An example embodiment 200 of the mobile terminal 100 is illustrated in more detail in FIG. 2. The mobile terminal 200 comprises a speaker or earphone 202, a microphone 205, a display 203 and a set of keys 204 which may include a keypad 204a of common ITU-T type (alpha-numerical keypad representing characters “0”-“9”, “*” and “#”) and certain other keys such as soft keys 204b, 204c and a navigation key 211 or other type of navigational input device such as a joystick. The keypad 204 and navigation key 211 are two examples of common input means.

The internal component, software and protocol structure of the mobile terminal 200 in an example configuration will now be described with reference to FIG. 3. The mobile terminal has a controller 300 which is responsible for the overall operation of the mobile terminal and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various software in the mobile terminal. The software includes a real-time operating system 320, drivers for a man-machine interface (MMI) 334, an application handler 332 as well as various applications. The applications include a browser application 350, as well as various other applications 360 and 370, such as applications for voice calling, video calling, sending and receiving SMS, MMS or email, an instant messaging application, a phone book application, a calendar application, a control panel application, a camera application, a media player, one or more video games, a notepad application, etc. An application cooperating with some of the applications listed above could be an editor application that could be a standalone application or a sub part of the application using it.

The MMI 334 also includes one or more hardware controllers, which together with the MMI drivers cooperate with the display 336/203, keypad 338/204 as well as various other I/O devices such as microphone, speaker, vibrator, ring tone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, i.e., band pass filters, amplifiers, mixers, local oscillators, low pass filters, AD/DA converters, etc.

The mobile terminal also has a SIM card 304 and an associated reader. As is commonly known, the SIM card 304 comprises a processor and local work and data memory.

In a mobile phone, such as the mobile terminal 200, using a text editor application a user can input text, numbers or other character strings by typing in a keypad sequence using the keypad 204, which is most commonly an ITU-T keypad. The text editor application may for instance be included in any of aforementioned applications 350-370. The characters making up the key sequence are interpreted as they are typed in according to a specified input mode. The typical editor application has three input modes: predictive input, multitap input and number input, and variations of these.

As input in the form of an input sequence is received via the keypad the input is interpreted by the text editor application according to the current input mode. The various input modes decide whether the input is to be perceived as a letter in lower case, as a letter in upper case, a potential letter belonging to a group of characters in lower case, a potential letter belonging to a group of characters in upper case or a number. As the skilled person realizes, the input could also be interpreted as a character other than a letter such as a punctuation mark or some other character. A single press, at the beginning of a new word/letter, on the key [2/abc] would be interpreted accordingly depending on the current input mode, see table 1.

| | Interpretation |
|---|---|
| Input Mode | (using common English letters) |
| [−>abc] | ‘a’, ‘b’ or ‘c’ |
| [−>Abc] | ‘A’, ‘B’, or ‘C’ |
| [−>ABC] | ‘A’, ‘B’, or ‘C’ |
| [abc] | ‘a’ |
| [Abc] | ‘A’ |
| [ABC] | ‘A’ |
| [123] | ‘2’ |

As one can see from Table 1, the interpretations for input modes [->Abc] and [->ABC] are the same. The difference between the two input modes is that when using [->Abc] the input mode is switched automatically to [->abc] once the first character has been received. The same situation applies analogously to the input modes [Abc] and [ABC].

As is commonly known, to input the name “Charles” using [->Abc], the user types the following key sequence: 2 4 2 7 5 3 7. Pressing the ‘*’-key once would change the input string to “Charler”.

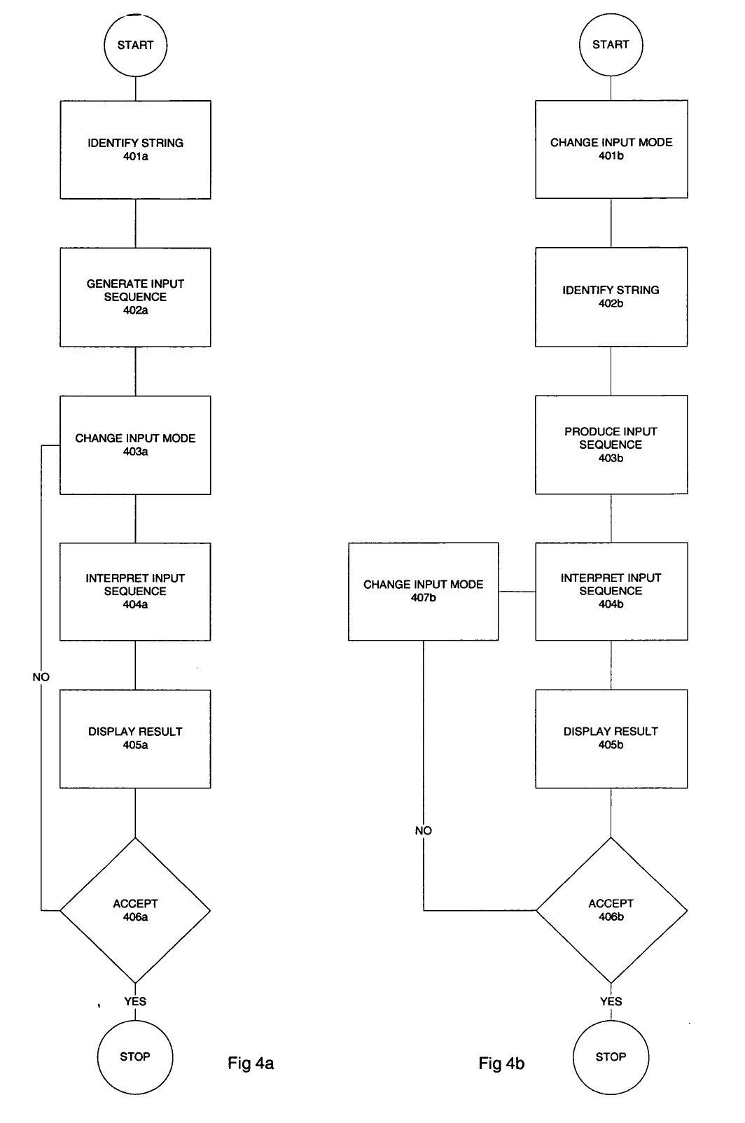

One example embodiment of the present invention uses input mode select means in the form of the hash key (‘#’-key) as an input mode switch key as described in the background section. To correct an erroneously input string, which has been received via an input means, using the invention (see FIGS. 2 and 4a) the string to be corrected is identified in step 401a by the text editor application and marked on the display 336. Then, an input sequence is generated in step 402a by converting the identified string, also referred to as the original string, to a corresponding input sequence as it would have been typed in using the keypad 204a. The next step 403a is to select a new input mode 403a by activating the input mode select means thereby generating a command to change input mode which is received by the text editor application 360 wherein a new input mode is established. Then the string is converted by the text editor application 360 accordingly by interpreting the input sequence under the new input mode 404a. The new resulting corrected string is displayed 405a on the display 336 replacing the original string. The input mode change or re-interpretation of the string can then be accepted either by demarking the string or by continued text input in step 406a. Activating the input mode select means again brings us back to step 403a.

In another example embodiment show in FIG. 4b, the string is already marked for editing when the user indicates that he wants to correct it by actuating the input mode select means in step 401b, in which case the original string is identified in step 402b as the already marked string. An input sequence is generated in step 403b, and the input sequence is interpreted according to the input mode in step 404b, and displayed in step 405b. If the user does not accept ie declines or rejects the corrected string in step 406b, by selecting a new input mode in step 407b, the method goes back to step 404b and continues in such a fashion until the user accepts the corrected word.

In the two embodiments shown in FIGS. 4a and 4b, user interaction is only necessary in two steps and one step, respectively.

Activating the input mode select means can be done by either longpressing the hash key (‘#’-key) or simply pressing it depending on the implementor's choice of how to group the input modes.

An alternative to transforming the string to an input sequence in step 402 is to remember the input sequence, wherein the editor does not need to transform the string back and forth between input sequence and string. If this is the case generating the input sequence simply involves fetching the input sequence form the memory 302.

Another alternative would be to only convert the affected characters in the string, e.g., the first character when changing between all lower case and first letter upper case input modes.

Naturally the marking could be done in a number of ways, such as highlighting, encasing, changing font to bold face or italic face, reversing colors or marking with special characters or figures such as arrows or any combination of these. Examples are (non-exhaustive list): marked, marked, marked, marked, >marked<, +marked+, [symbol] marked [symbol] , [symbol] marked [symbol] or →marked←.

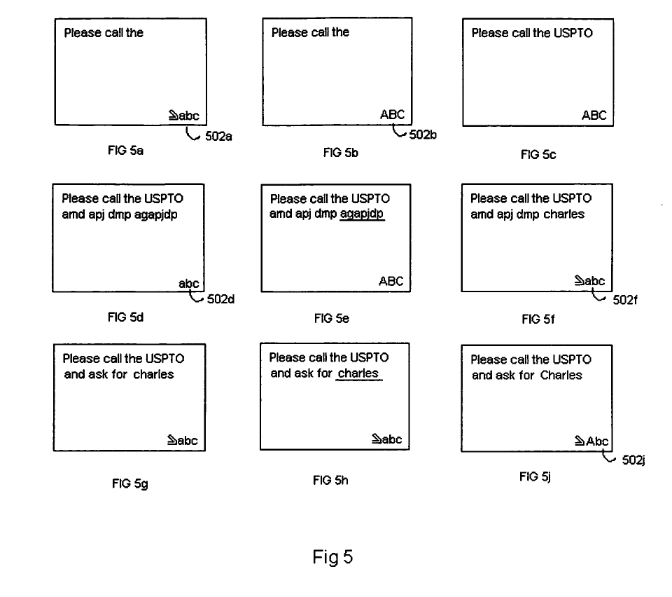

An example of how an embodiment could be controlled by a user is shown in FIGS. 5a-j. A user wants to input the string “Please call the USPTO and ask for Charles”. He starts typing using the Predictive input mode (as indicated by symbol 502a), and he proceeds normally through the string “Please call the ”, see FIG. 5a, but when it is time to input “USPTO”, which is not in the dictionary, the user has to switch input mode to a multitap input mode. Thus the user switches to [ABC] (symbol 502b) and types in “USPTO”, see FIGS. 5b and 5c. Here the user forgets to switch back to the predictive input mode for some reason and continues typing thinking he is using a predictive input mode. However, the input mode is changed from all upper case [ABC] to [abc] automatically upon the input of a space character as indicated by symbol 502d. The user inputs the key press or input sequence {263 [space] 275 [space] 367 [space] 2427537} resulting in the text string “amd apj dmp agapjd”, see FIG. 5d. Using the invention, all the user has to do now is to go back to each word, mark it and change its input mode to [->abc], see FIGS. 5e to FIG. 5g. That is, [STEP BACK] (left on navigation key), [MARK] (left once again on navigation key), [CHANGE INPUT MODE] (hash key) and [ACCEPT] (left on navigation key 211). As the [STEP BACK] and [ACCEPT] will be the same action and the user does not have to step back to the last word, it only requires 4×3 key presses =12 key presses to change all four words.

If the user marks the whole string at once, for example by keeping the alpha key depressed while scrolling over the whole string, which could be done in just a few key presses as the string most probably extends over more than one line and the lines can be scrolled one by one, the correction could be done in only 3 operations, that is [MARK] (or [IDENTIFY]), [CHANGE INPUT MODE] and [ACCEPT], each requiring only 1 to 3 key presses averaging in 6 key presses in total to change the whole string.

If the user forgot to change input mode to [->Abc] when correcting “agapjd” to “charles” the first letter is in lower case, see FIG. 5g. To correct this the user makes sure that the name is marked for editing, ie underlined, FIG. 5h. To identify the word the user marks it which could be done by simply moving the cursor to it as is commonly known. Now that the word is marked the user presses the hash key once, thereby selecting the input mode [->Abc] (symbol 502j) and the word is re-interpreted and displayed as “Charles”, see FIG. 5j. Since this is what he wanted, the user should accept the word by either continue to type or demarking the word by for instance pressing right on the navigation key 211. If the user would continue pressing the hash key the following alternative strings would be displayed one by one: “CHARLES”, “2427537”, “agapjdp”, “Agapjdp” and “AGAPJDP”.

This ability to completely re-interpret and change a string that has been input under the wrong input mode is very useful as it allows a user to correct the string in a simple and easily understandable way. This is especially so when the user has been under the notion that he was using a predictive input mode when in fact he was using a multitap input mode and when more than one string has been input before the error was discovered.

The usefulness of switching between predictive and multitap input becomes more apparent if the string “nonmow” is changed using the method according to the present invention. Switching from predictive input to multitap input provides the following alternatives “now”, “Now” and “NOW”.

The generation of an input sequence in step 402a/b is necessary as some of the input mode changes otherwise would be impossible. A simple case change would not be able to create new characters such as a correction of a ‘c’ input under multitapping would do when being converted to predictive input, namely three characters belonging to the key [2abc] in a row.

The generation of the input sequence could be done at once for the whole string or character by character as each character is re-interpreted in the original string and exchanged for its corrected counterpart. If a change was then to be made from a predictive input mode to a multitap input mode, the next character would also need to be checked as characters belonging to the same key would possibly have to be collapsed. There are a number of words that could generate ambiguous results using the method as described above if the original input sequence was not stored in memory. One example is the name of the Swedish pop band “ABBA”. There is no way of knowing for an input sequence generator how to group the keypresses on the [2abc] key, unless the timeouts or acceptances, ie the next character commands, had been stored along with the original input sequence in the memory. If they had not been stored and an input sequence was to be derived simply from the word “ABBA”, the different possible candidates could be represented one by one and the user could either accept it or require a new interpretation. The re-interpretation could either be ordered by pressing the input mode select means again, ie the ‘#’-key in the examples above, or by scrolling through the alternatives using a candidate scroll key such as the ‘*’-key as is commonly done in predictive input systems to choose between candidates. See table 2 for different interpretations of candidates for the original string “ABBA” when changing input modes between predictive and multitap. When switching to predictive input mode from multitap input mode the string “ABBA” generates the input sequence [2abc] [2abc] [2abc] [2abc] [2abc] [2abc],ie six presses on the [2abc]-key, resulting in 729 basic combinations using only the letters ‘a’, ‘b’ and ‘c’. Only the one in the dictionary is shown.

Ambiguous results from any other input mode switch could also be handled in the same way as described above.

Table 2 below shows ambiguous candidates resulting from interpreting “ABBA” according to two different input modes assuming that only the three letters ‘a’, ‘b’ and ‘c’ are assigned to the affected key.

| Candidates for “ABBA” | Candidates for “ABBA” |
|---|---|
| switching from predictive input | switching from multitap input |
| mode to multitap input mode | mode to predictive input mode |
| AAAA | BACCAB |
| AAB | |
| ABA | |
| BAA | |
| AC | |
| CA | |

Another possible input mode that could be selected could be having the first character lower case and the rest upper case. Switching to this input mode in the example above (see FIG. 5) would generate the word “cHARLES”.

In another embodiment according to another aspect of the invention, the selected dictionary could be regarded as an input mode. The user could then change strings that have been input under the wrong language in a quick and easy way. In this embodiment another key could be used to change the dictionary input mode so that in the example above the hash key would be used to change input mode between predictive, number and multitap input mode and the alpha key could be used to change dictionary input mode.

It should be clear that the input mode select means need not be the hash key, but could be any key, virtual or physical, such as the ‘*’-key, a dedicated key, an alpha key as used in Symbian Series 60 terminals or a scroller key.

It should also be clear that the text input means for the text editor application could also be any type of keypad or keyboard, scrolling input listings, pen input groupings, etc.

Although the descriptions above have been focusing on input using an ITU-T keypad having 12 keys, the invention could also be implemented using a rotator input such as the one used in the NOKIA 7280™. Instead of having an input mode switch key, selecting a wanted input mode switch icon from the input banner while the string is marked would be used to change the input mode of the string.

It should be noted that the present invention could also be used with pen input whereby the keypresses are exchanged for penstrokes and virtual keypresses.

The present invention could also be used with more advanced keyboards such as a QWERTY-keyboard as the invention still holds benefit compared to normal error corrections. For a QWERTY keyboard the CAPS Lock key would be the input mode switch key, and for keyboards with numeric pads that have been used without the Num Lock activated, the Num Lock would be the input mode switch key. To better describe the feature used in this last embodiment see the following example. A user wanted to input the number 123456 and used the keypad present on many keyboards to speed up the number input. For some reason the user does not notice that the Num Lock is not activated and instead of inputting the number 123456 the user inputs the command change [Go to end], [Scroll down], [Page down], [scroll left], [Nothing] and [Scroll right]. As the user would be unable to mark the string that he wants to correct he could mark that he wanted to change the last input string that could have been interpreted as a number string by making a longpress on the Num Lock-key or alternatively pressing Ctrl+Num Lock or some other key combination.

The invention as described above could also be used for converting already input text that is somehow stored in or received by the device.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A method for string conversion comprising the steps of:
identifying an original string for correction;
receiving a command specifying an input mode;
generating an input sequence corresponding to said original string;
interpreting said input sequence according to said input mode thereby generating a corrected string; and
replacing said original string with said corrected string.

2. A method for string conversion according to claim 1, wherein the step of identifying an original string for correction includes involves marking said original string.

3. A method for string conversion according to claim 1, wherein said step of receiving a command specifying an input includes detecting activation of an input mode select means.

4. A method for string conversion according to claim 3, wherein said activation of input mode select means includes pressing a key.

5. A method for string conversion according to claim 1, wherein said step of generating an input sequence corresponding to said original string includes fetching said input sequence from a memory.

6. A method for string conversion according to claim 5, wherein said fetching also involves fetching a next character command input as part of said input sequence.

7. A method for string conversion according to claim 1, wherein said step of generating an input sequence corresponding to said original string includes creating an input sequence from the original string by mapping said original string to an input means being used.

8. A method for string conversion according to claim 7, wherein said step of generating an input sequence corresponding to said original string includes creating an input sequence from the original string by mapping said original string to actuations of a text input means having resulted in said original string prior to said of step of identifying an original string for correction.

9. A method for string conversion according to claim 1, wherein said original string represents a number.

10. A method for string conversion according to claim 1, wherein said corrected string represents a number.

11. A method for string conversion according to claim 1, wherein said input mode is a predictive input mode.

12. A method for string conversion according to claim 1, wherein said input mode is a multitap input mode.

13. A method for string conversion according to claim 1, wherein said step of interpreting said input sequence according to said input mode thereby generating a corrected string results in more than one candidate for said corrected string, and said step of interpreting said input sequence according to said input mode thereby generating a corrected string includes a step of displaying one of said more than one candidate and upon activation of a candidate scroll means displaying another one of said more than one candidate.

14. A method for string conversion according to claim 1, wherein said input mode is a dictionary input mode.

15. A method for string conversion according to claim 1, wherein said input mode is selected from the set consisting of Predictive input, Multitap input and Number input.

16. A computing device comprising:
a processor; and
memory containing computer readable instructions instructing said processor to perform steps comprising:
identifying an original string for correction;
receiving a command specifying an input mode;
generating an input sequence corresponding to said original string;
interpreting said input sequence according to said input mode thereby generating a corrected string; and
replacing said original string with said corrected string.

17. A computing device according to claim 16, wherein the device is a mobile communications terminal.

18. A computing device according to claim 16, wherein the device is a personal computer.

19. A computer readable medium having computer readable instructions stored thereon that, when executed in an electronic device, performs steps comprising:
identifying an original string for correction;
receiving a command specifying an input mode;
generating an input sequence corresponding to said original string;
interpreting said input sequence according to said input mode thereby generating a corrected string; and
replacing said original string with said corrected string.

20. A computing device having converting means for converting strings, said converting means comprising:
means for identifying an original string;
means for generating an input sequence from said original string;
means for establishing an input mode;
means for interpreting said input sequence according to said input mode and generating in a converted string; and
means for replacing said original string with said converted string.
